(19) United States
(12) Patent Application Publication
(10) Pub. No.: US 2003/0005150 A1
(43) Pub. Date: Jan. 2, 2003

(54) Telecommunications interface

(76) Inventors: Stephen M Thompson, Woodbridge (GB); Christopher H Seal, Woodbridge (GB)

Correspondence Address: Nixon & Vanderhye, 8th Floor, 1100 North Glebe Road, Arlington, VA, 22201-4714, US

(21) Appl. No.: 10/149,080

(22) PCT Filed: Jan. 10, 2001
(86) PCT No.: PCT/GB01/00086

(30) Foreign Application Priority Data
Jan. 10, 2000 (GB) 0000464.8

(51) Int. Cl. G06F 15/16; G06F 15/173

(52) U.S. Cl. 709/238; 709/249

(57) ABSTRACT

A telecommunications interface 12 is connected between a voice network 10 (for example the PSTN) and a data network 11 (for example the Internet). Calls from a caller 14 for a recipient 18 are directed to the gateway which accesses user information from a profile 15 to determine how the call is to be routed. The user profile is generated by reference to an appointment calendar 16 (for example Microsoft Outlook), and/or by reference to an organisational hierarchy. Rules based diversion is also provided so that certain calls originating from pre-specified callers (identified by network Calling Line Identification signals) are handled in a more specific manner than calls to the default destination.

The present invention relates to a telecommunications interface and more particularly, but not exclusively, to an interface between a connection oriented network and a connectionless network.

There have been a number of arrangements proposed to enable completion of calls to a designated telephone number when the person being called is not at that telephone number. So-called personal numbers usually allow the customer to select a fixed network telephone number and a mobile (cellular) network telephone number to which calls may be diverted. Such arrangements require either that the customer contacts a service provider's system to notify which number to try preferentially or for the numbers to be tried in turn. In other arrangements calls to a particular telephone number may be diverted on the basis of a Day of Week/Time of Day fixed program. One such arrangement is disclosed in European Patent Specification No. 0954193. In all of these cases some deliberate notification activity to the network service provider is required.

According to one aspect of the present invention there is provided a telecommunications interface in a communications network, the interface comprising means responsive to each call to one of a plurality of users of the network to access user provided profile data at a node of the network, said profile data relating to the respective user and to determine from said profile data and from data defining identity of a calling party in a current call a preferred destination for the current call in either the originating network or in an alternative network characterised in that the user profile data is derived from a schedule or electronic diary to determine from location data entered by the user a preferred destination for the current call.

Preferably the interface is located between a connection oriented and a connectionless network and uses profile data from the connectionless network to determine the preferred destination.

The preferred destination may be in the connection oriented or in the connectionless network.

The data defining the calling party may be calling line identification (CLI) data originating in the connection oriented network and the profile data may include data defining a preferred destination for each of a plurality of specified CLIs.

Each of said plurality of CLI's may have respective data defining time related destination identities or there may be a single profile for a plurality of specified CLI's.

Preferably also the user profile data includes data defining a preferred destination for any call originating other than from a specified CLI or CLIs which data may be time oriented and/or call type oriented. The User profile data may refer to a schedule or electronic diary to determine from location data entered by the user a preferred destination for the current call.

The interface may include means responsive to user profile data to transmit to a user telephone appointment or alarm information either directly to a user telephone using interactive voice messaging or by transmitting a data message to the user telephone or to a pager or other destination specified by the user profile.

According to a second aspect of the present invention there is provided a telecommunications routing agent responsive to calls directed to a communications user's address to determine, from data derived from the respective communications user's personal electronic schedule and a respective personal profile script, a routing within at least one telecommunications or data network for each such call, said routing being further dependent upon the identity of a calling party.

The telecommunications network may be a connection oriented or connectionless network and is preferably a connection oriented network such as the public switched telephone network (PSTN).

The data network may be a connectionless network such as an Internet or intranet, the users personal profile data and/or personal electronic schedule being retained in the connectionless network.

A telecommunications interface and a telecommunications routing agent each in accordance with the invention will now be described by way of example only with reference to the accompanying drawings of which:

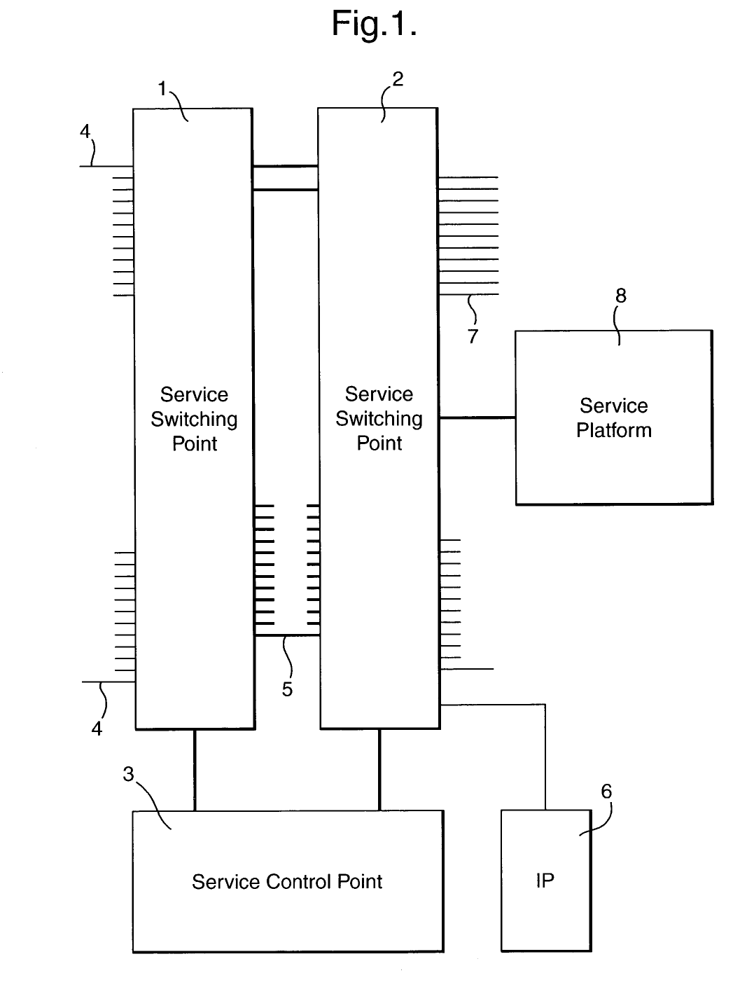

FIG. 1 is a block schematic diagram of a connection oriented telephone network;

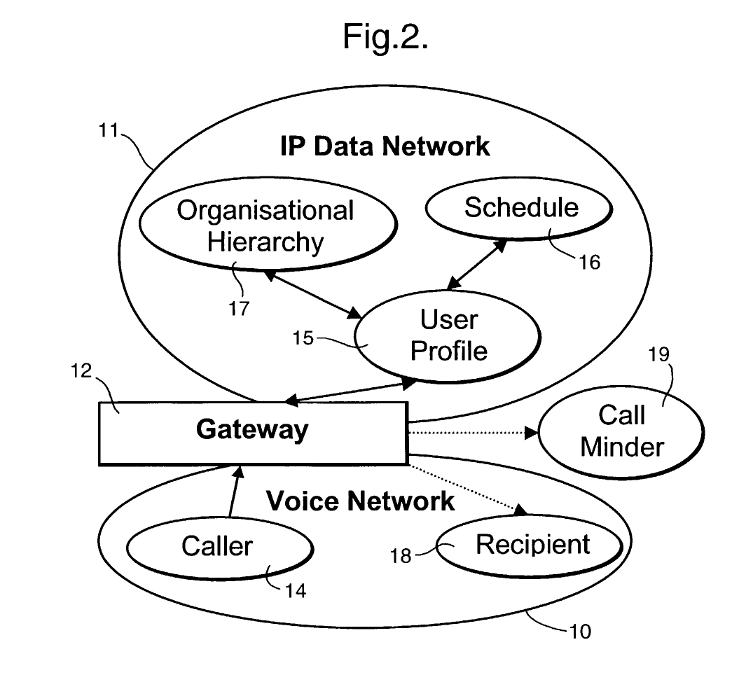

FIG. 2 is a schematic network diagram showing the interface of the present invention;

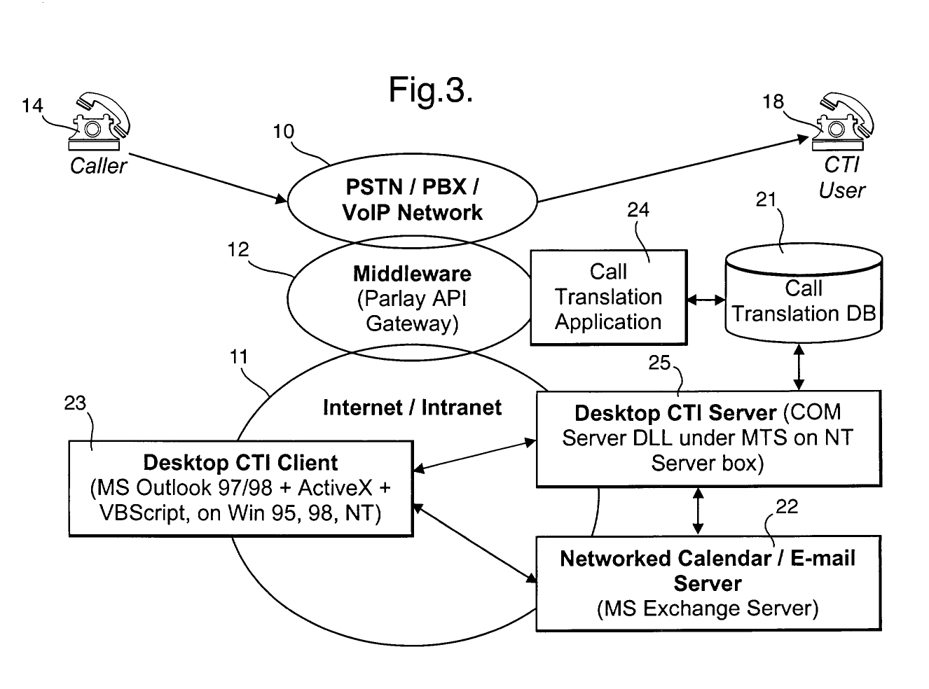

FIG. 3 is a more detailed schematic diagram showing call routing using the interface;

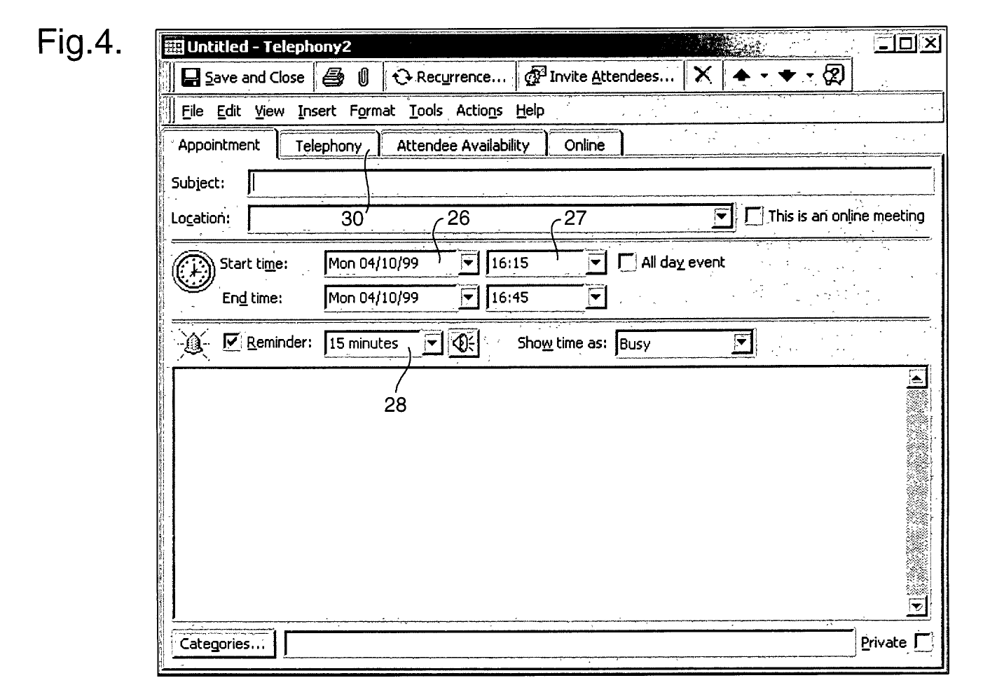

FIGS. 4 to 7 are representations of modified screen presentations of a calendar or schedule program;

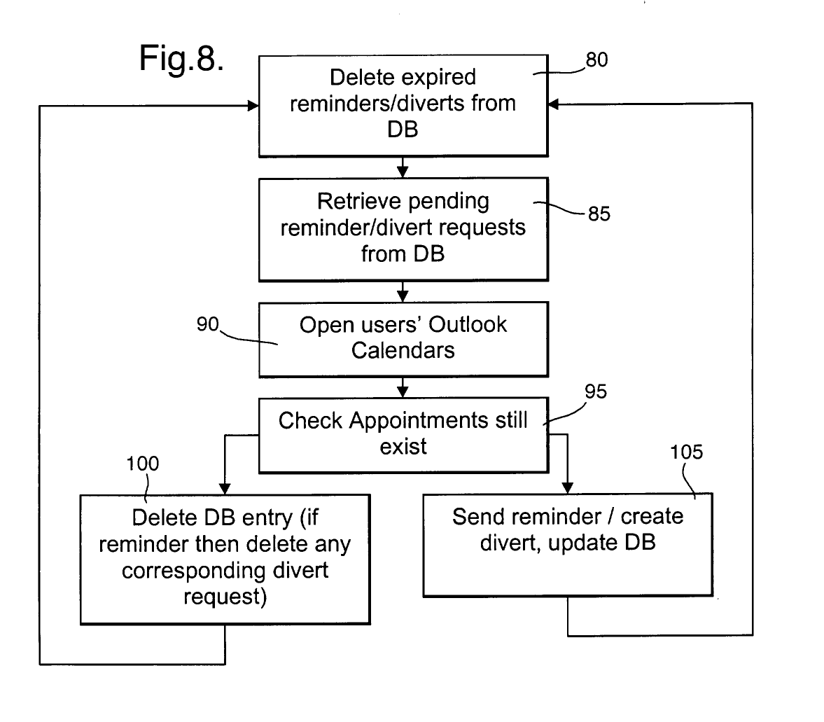

FIG. 8 shows a flow chart of a program used in checking destination validity.

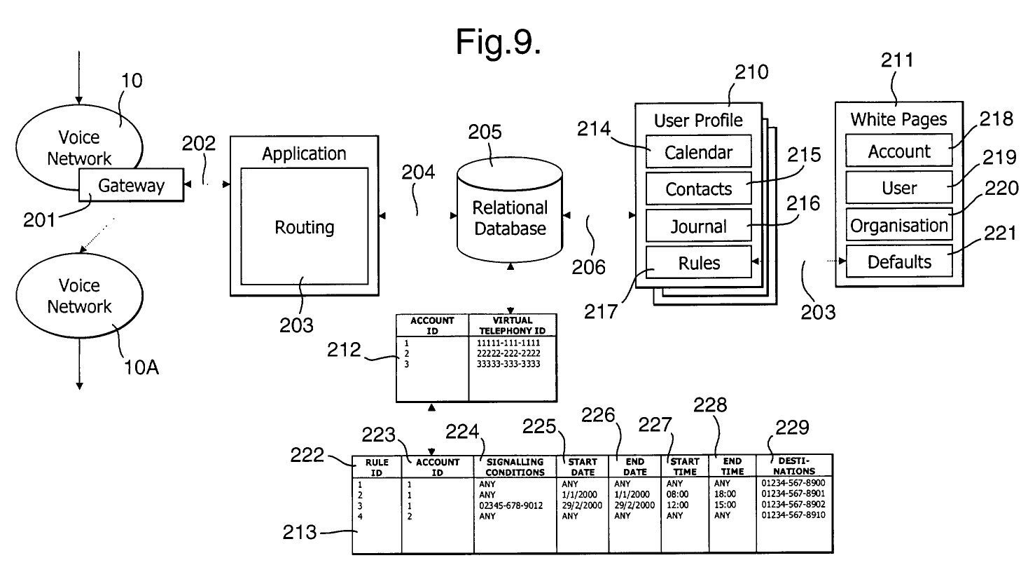

FIG. 9 is a block schematic diagram giving an overview of network oriented agent connection using a simple database look up method;

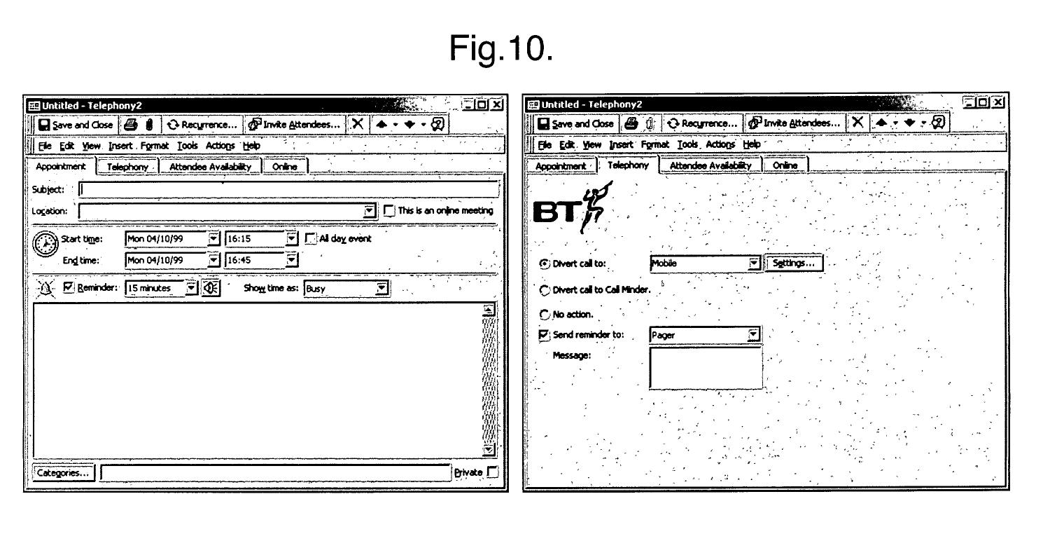

FIG. 10 show typical diary entry window display screens used in a calendar or schedule program;

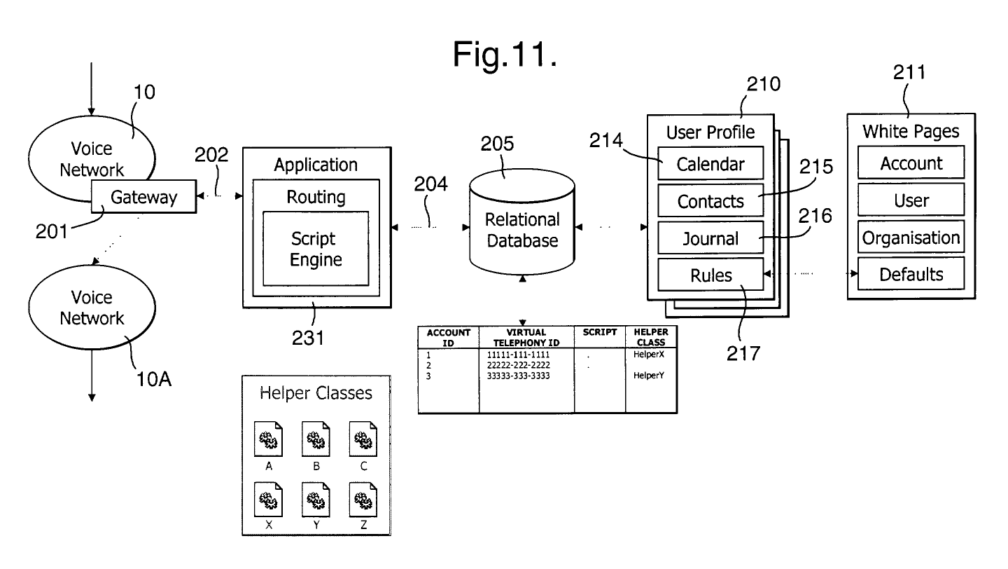

FIG. 11 shows a block schematic diagram giving an overview of class script processing for an incoming voice call;

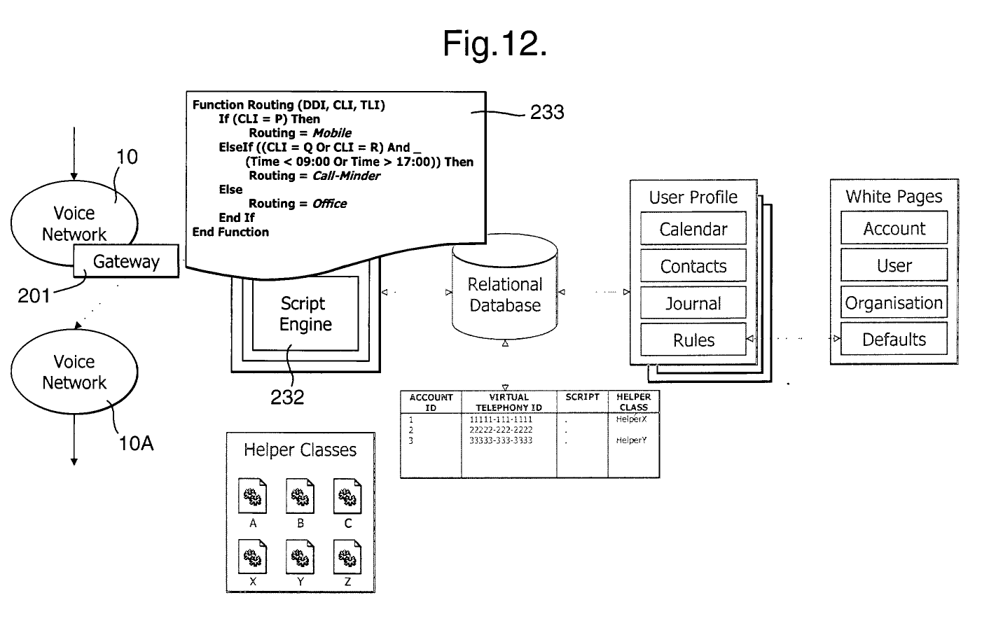

FIG. 12 shows an example of a simple script used in the system of FIG. 11:

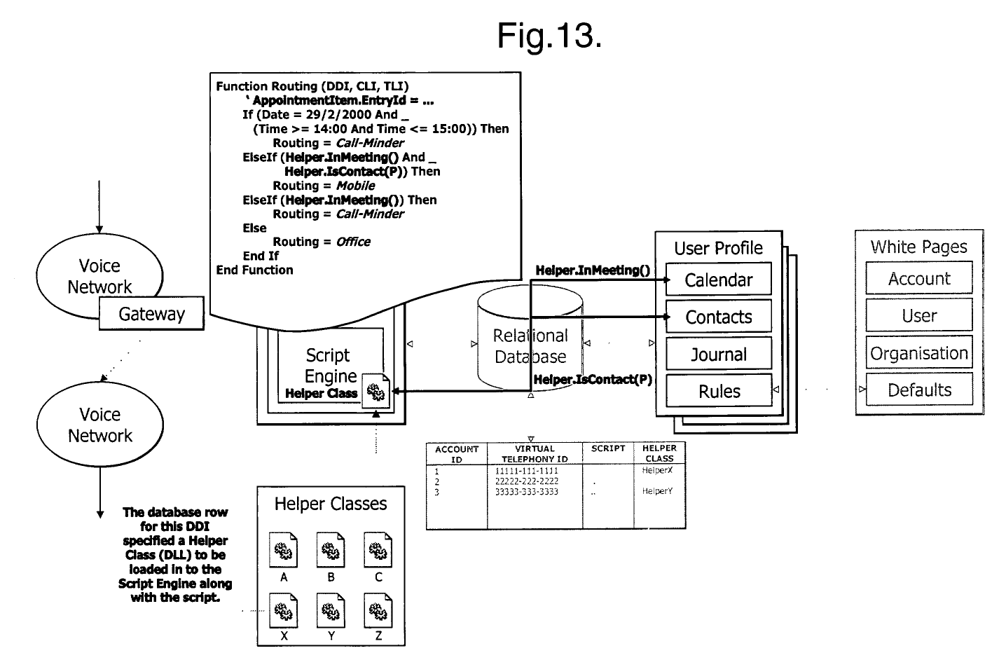

FIG. 13 shows an example of a helper class assisted script used in the system of FIG. 11; and

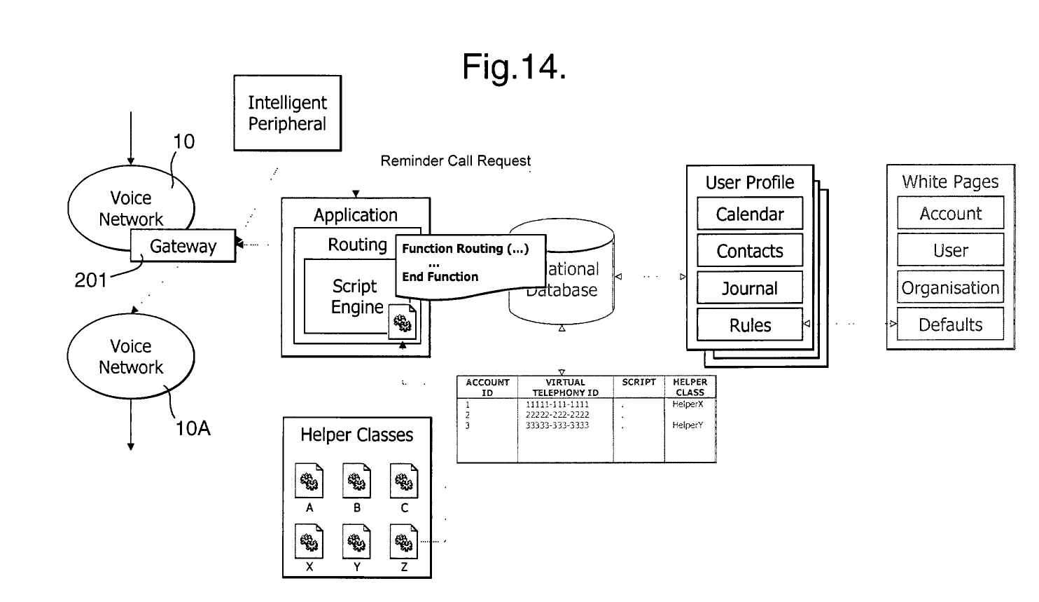

FIG. 14 shows a block schematic diagram giving an overview of a calendar originated reminder call;

Referring first to FIG. 1, a so-called intelligent telecommunications network comprises a number of telephone exchanges or service switching points (only two of which are shown for simplicity) 1,2. The service switching points are interconnected to provide connections between customer lines 4, 7 which are connected to customer premises to provide telephony service for example. Each of the customer lines 4,7 is a fixed node of the network which is connectable to any other fixed node 4,7 of the network, each such node being identified by a telephone number which is transmitted by a calling customer to a service switching point 1,2. Within a service switching point 1,2 processor control (not shown) software programs examine numbers signalled by calling customers to determine if the call connection is within the capability of the service switching point or whether further intelligence is required to effect “number translation”. If further intelligence is required (for example because of the particular code dialled indicates a special call type) then the Service switching point may transmit a message to a service control point 3, the message including data defining the origin of the call and the signalled telephone number. The service control point 3 determines how the call should be handled and returns a message to the service switching point instructing how the call is to be further connected.

The further connection may be to a service platform 8 for providing special facilities such as an answering service for example or to a so-called intelligent peripheral 6 which may provide prompt and collect facilities for example to transmit a voice message to the calling customer and to collect responses from the customer to provide further information on the continued re-direction of the call. In any event, there is always an individual connection from the calling customers telephone through the network to the destination whether by individual physical link, for example a copper wire, or by virtue of an allocated digital channel. Thus this type of network is referred to as connection oriented.

Recent developments in data networks have led to such as the so-called “world wide web” or internet and also to intra-nets which interconnect desk top computers, servers and the like. These networks tend to operate by transmitting data messages having a header which defines a destination address and an originating address for example. There is no dedicated path between the originating device and the destination device, the header being used to direct data messages across a shared network until it reaches the addressed port. Thus it is possible for consecutive messages from one computer process to another computer process to take different routes through the network. The kind of data messaging network uses defined signalling protocols for example Internet Protocol (IP) currently IP4 (but likely to become IP6) or other defined protocols on intra nets for example. These networks are, because there is no fixed path between any two nodes, usually referred to as connectionless networks.

Most connection oriented networks have interconnect points with connectionless networks such that connectionless network traffic can be transferred from the connection oriented network (on which customers may have personal computers for example) to the connectionless network and vice—versa. Data generated within a personal computer by processes running in that computer may have an individual originating/terminating address relating to each process. Thus, although a part of the communication may be on a connection oriented network the transfer of data between different processes may still be in a connectionless manner.

Referring now to FIG. 2, the present invention is intended to integrate a voice (connection oriented) network 10 with an IP data (connectionless) network 11 through a gateway (telecommunications interface) 12. The gateway 12 on receiving data defining a call from a caller 14 in the voice network 10 consults a user profile 15 in the IP data network 11. The user profile has access to the user's schedule 16 and organisational data 17 from which can be determined the attributes to be associated with each call for the user. Thus the gateway 12 may derive from the user profile 15, users schedule 16, the calling line identity of the caller 14, organisational data 17 an actual telephonic destination for the call in the voice network. The selected destination may be the called person (recipient) 18 by way of a mobile phone or one of a possible multiplicity of other network nodes. Alternatively the call may be routed to an answering service (for example the proprietor's network based “call minder” (Trademark) service 19. Call diversion of specified CLI originating calls to a third party, for example a manager or secretary may also be carried out.

Thus the system provides flexibility of destination based upon several user inputs selected from data provided by the user for other than telephony purposes. This flexibility is enhanced since the user schedule 16 may be the calendar program to which other persons may enter data such as by use of automatic meeting setting programs, secretarial arrangements or management or other schedulers. The system is not limited to consulting a single schedule 16 if the user profile 15 indicates that multiple schedule programs are in use. The gateway 12 may thus derive an overall schedule from a plurality of schedule programs and take in to account all inputs before determining the routing of a call from caller 14 to recipient 18.

Thus in calendar call routing mode, incoming calls to a personal number are routed to a destination selected from the current appointment in the calendar and a user profile. This allows call routing to be performed on an appointment by appointment basis. Thus, for each appointment in the user's schedule a destination may be selected for some or all incoming calls for example:

The existing destination (pre notified in the user profile 15) for example the user's desk telephone, a meeting room phone or a mobile phone;

A call answering service with or without a notification being transmitted to (e.g.) a text or other pager;

Ring multiple destinations simultaneously and connect the call to the first to answer;

Ring multiple destinations sequentially and connect the call to the first to answer within a pre-specified time;

Route to default rule destination;

Route to any other specified number.

Rule based routing in the user profile may be used to override appointment settings, for example calls originating from calling number “X” (defined by CLI) should always be connected to destination “Y”.

Where there is no calendar appointment shown then incoming calls are always routed according to the rules in the user profile. Thus “before 8 pm and after 5 pm route calls to call answering otherwise route to desktop phone” may be included as a default rule which may be overridden by CLI based rules (as mentioned in the preceding paragraph). Where there is a calendar based appointment then telephony rules related to the appointment location are used which may again be over ruled by CLI based rules.

Certain CLI rules may result in multiple ring calls across several users—for example if an organisation has a number of people who may deal with a particularly important call CLI based rule in one persons user profile (or an organisational “master” profile) may cause a multi ring call to diverse destinations determined from more than one user profile so that the caller is quickly connected to the first available (first to answer) call recipient.

The advantages of the system to the user include the integration of telephony diversion within existing desktop applications such as the calendar function of Microsoft (trademark) Outlook or Schedule/Schedule plus type programs; a simple to use system without the need to duplicate data input, call routing being based on an existing calendar application; the incoming caller does not need to know (nor need be revealed) personal numbers such as home telephone numbers or personal mobile numbers;

In order to perform the tasks required of it, the gateway 12 expects a user profile 15 identified by and containing a personal number to include primary contact details such as a home telephone number, a desk number, mobile number, secretary, manager, subordinates and pager number for example. Each of these may be specified in data fields allocated for those numbers which exist and the calendar or profile software will offer multiple choice destinations when the user inputs either a calendar appointment or user profile data at the desktop.

Rule based routing is simple to effect using language such as

“always” or “between . . . and . . . ” “Monday to Friday” “Weekend”

send calls from CLI . . . to . . .

never send calls from CLI . . . to . . .

Send all calls before/after . . . to . . . otherwise send all calls to . . .

Never send calls after . . . to . . .

The rule based routing program includes “sanity” checks to ensure that the user is alerted to potential conflict between rules as they are created.

The gateway 12 may also be arranged to provide appointment reminders based on schedule 16. Calendar software typically provides reminders through a “pop-up” dialog window. The Gateway 12 may be used to forward reminders to a text pager or telephone with text display or may call the user (based on current location) and use text to speech conversion to provide appointment information to the user. The gateway may also be used to enable the user (or other authorised caller) to query the users schedule 16 using an inter-active voice system.

The gateway 12 may also be used to facilitate the establishment of conference calls for example by using a calendar programs ability to schedule a meeting with several users by way of electronic (e-mail) messaging. Following acceptance of a request to join a conference at a specified time the gateway 12 will automatically call all of the participants at the appropriate time. Calendar call routing as mentioned above can be used so that the call is established to each participant based on that user's location at the time of the call.

Where incoming calls are unanswered the gateway 12 may be able to provide helpful information to the calling party, for example (subject to user profile rules), the gateway could use calendar information to inform the users current location and the expected duration of appointments together with a message indicating the time at which the called party is expected to be available to take calls prior to connection to the answering service.

Persistent callers (determined from CLI for example) or senior management calls could be diverted to “all telephones in a selected group”, or to the secretary or through identity of project groups or line management responsibilities in the organisational hierarchy 17.

Turning now to FIG. 3, calendar call routing application may be implemented using Microsoft Outlook 98 client coupled with the Microsoft Exchange Server program 22. Using the Outlook forms programming environment with the Active X control function and VBScript language schematically represented at 23. Call translation requests are held in an Oracle8 (Trademark) database 21. The call translation application 24 and the gateway 12 are built using Parlay API standards specification (currently available at http://www.parlay.org). The gateway 12 is located between a connection oriented network 10 such as the Public Switched telephone Network (PSTN) a private telephone system (PBX) or a voice of IP network.

If the computer/telephony integration (CTI) server 25 is not integral with the desktop CTI client server suite then it may be provided separately using a suitable PC server to provide an interface between the calendar 22, and call translation applications.

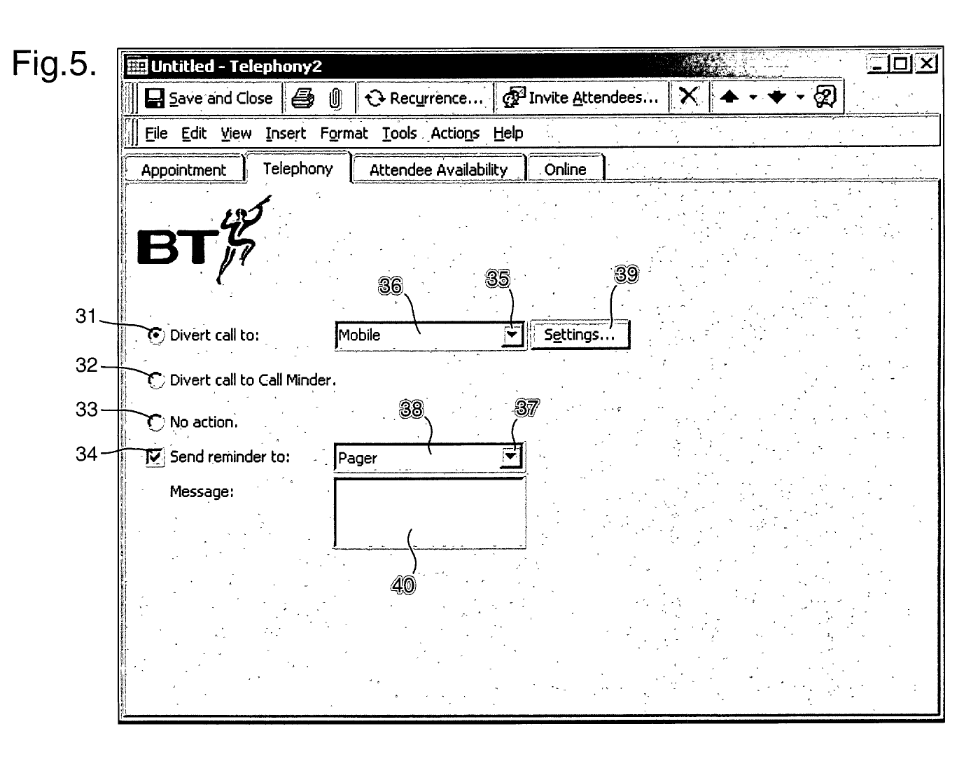

The desktop CTI client 23 is implemented by extension of the functionality of Microsoft Outlook (currently MS Outlook 97 and 98 versions) using the MS Outlook Appointment form. Thus, referring to FIG. 4, a telephony tab 30 is added to the windows display of the Outlook appointment form so that the when the user completes an appointment form simply using a point and click operation the user is taking to a telephony sub window which is shown in greater detail in FIG. 5 to which reference is now made.

In the telephony window display form of FIG. 5, point and click options are provided to the user to enable selection of the options to be carried out during this appointment. Thus by clicking on the “Divert to Call Minder” selection 32 all calls, unless from a CLI having an overriding rule in the user profile, will be diverted to the answering facility. Clicking on the “no action” selection 33 leaves calls following the default rules from the user profile for the duration of the current appointment.

By selecting the “divert to” option 31, the customer is offered a drop down menu 35 with the more recently used or most likely option showing in the selection port 36. The drop down selection menu will offer all options currently held in the user profile.

In addition to selecting telephony options for the duration of the appointment the user also has the opportunity to have a reminder message by text or text to voice. Selection of this option using port 34 allows selection of a message destination in port 38 using a drop down menu from tab 39. Again the drop down menu will include all available options from the users profile including pager, sms text to phone and text-to-voice phone messaging.

The transmitted message may either be directly derived from the information entered in the appointment pro-forma or may be a specific message entered for the purpose in the telephony form in port 40. The reminder message (if selected) is transmitted in accordance with the timing dictated in the appointment form (FIG. 4) based on the selected day and start time (ports 26 and 27) and the reminder request timing (port 28)

If a reminder request is not set in the appointment from of FIG. 4 then a default time period from the user profile will be used if a reminder is requested in the telephony proforma.

The settings tab 39 allows the user to update (e.g.) telephone numbers in the user profile as hereinafter referred to.

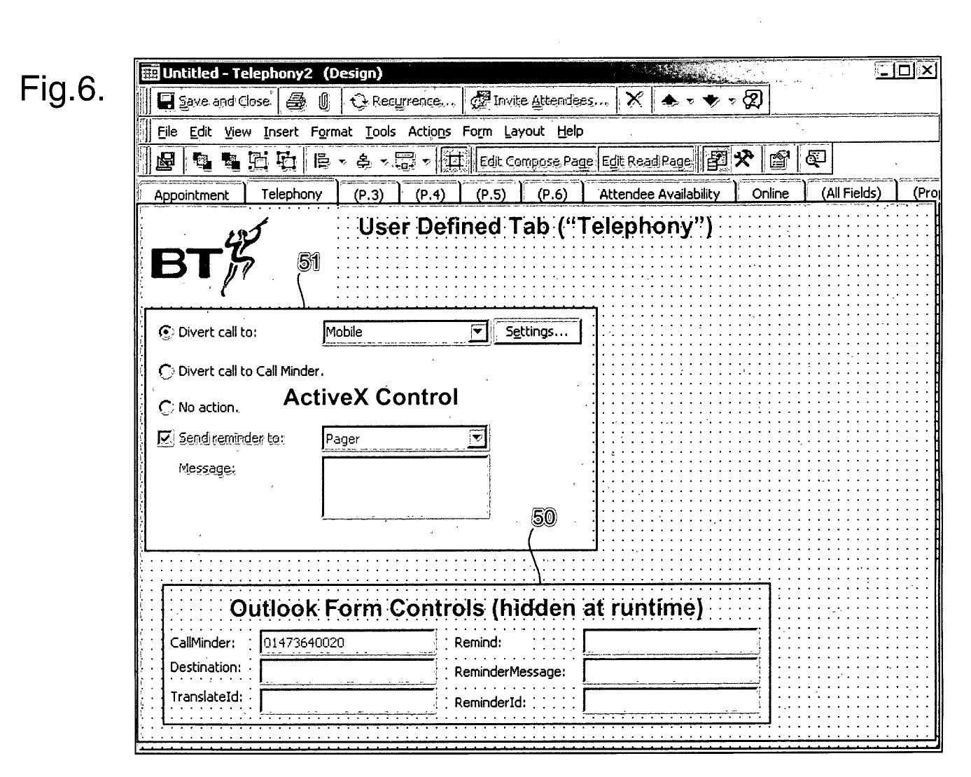

Referring now to FIG. 6, the design time view of a user defined tab in Microsoft Outlook is shown. The following components can be seen although the Object Model exposed by Outlook does not show all events or functionality. (The Object Model referenced here, at the date of this patent application, may be seen at

http://www.microsoft.com/OutlookDev/Articles@Outprog.htm).

Outlook Form Controls 50 enable cross referencing of requested actions to the call translation database (21 of FIG. 3).

ActiveX Controls 51 enable capture of call handling requirements, accessing of the user profile and communication with the desktop CTI Server (25 of FIG. 3).

VBScript Event Handlers are used to effect the functionality of the Active X Controls and the rest of the form.

The dotted area represents the background of the form display area which is inactive.

The telephony tab contains the following controls and/or user properties used to contain state information:

“Callminder” The fixed call minder (answering service) number to be used—this could 1 also be a configurable part of the user profile information.

“Destination” A number to which incoming calls are to be diverted. The purpose of this field is to select the correct options on the GUI when the form is re-opened.

“translated” Cross reference to the Call Translation Database

“Remind” Number to which a reminder if any is to be sent. This is used to keep the GUI consistent with the database.

“Reminder/Message” reminder message to be sent if not the default message.

“Reminderld” Cross reference to the messaging data base.

The ActiveX Control is used to implement the call translation facility. Outlook form Controls/User properties may not be satisfactory for implementation of the call translation request functionality as if another user received an invitation to a meeting for which the organiser had set telephony options the invited user also saw the originators telephony settings before the meeting was accepted. This feature could result in unwanted disclosure of telephone numbers to an invited party such that in preference Microsoft distributed COM was used to communicate with the server component so that data base entries are created for call translation requests (and for updating call translation requests) and for reminder messages. The returned keys from the COM entry are then stored in the form's User Properties.

Where CTI is provided as an add-on facility to an existing system then TCP socket connection could be provided as an alternative communications channel.

The VBScript event handlers used by the present arrangement are:

“Item_Open( )” Configures ActiveX control when the form is displayed;

“Item_PropertyChange( )” Appointment updates reflected in ActiveX Control

“Item_Write( )” Activated when the form is being saved, or a modified form is being closed. Calls the public method of the ActiveX control requesting calls to be diverted, and update Form's User Defined Fields. If the form is not visible (e.g. the time of an appointment is being changed by dragging it—without opening—in the Outlook calendar) then an instance of the ActiveX object is created.

“Item_Close( )” Updates Outlook Form controls with database cross-references.

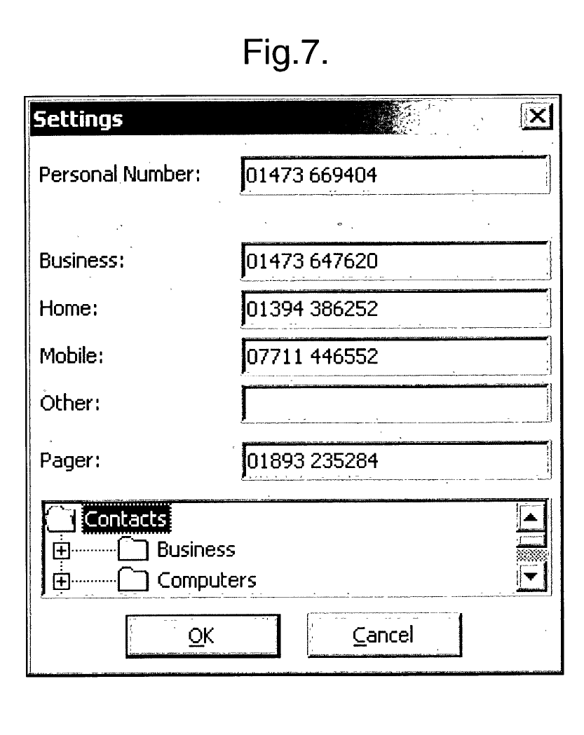

Referring now to FIG. 7, the user profile comprises a set of phone numbers and a default destination to which calls to the personal number are normally sent. As previously mentioned, this profile is accessed through the settings tab (39 of FIG. 5). These settings may be stored as an Outlook Contact item and could be configured from existing contact entries. The default routing is stored in an Oracle8 database which is used by the application performing number translation for the connection oriented network. For preference in implementation however the User Profile is held with a full set of user rules as a central component on the desktop client program which would determine how incoming calls are handled.

The functions of the Desktop CTI server (25 of FIG. 3) include writing call translation requests and reminder message requests from the client 23 in to the database 21. The desktop CTI is also the operable component for promoting call translation request to an actual call divert on call arrival and will trigger distribution of the reminder messages.

Prior to transmitting a reminder message or activating a diversion the CTI server checks to determine if an entered appointment still exists since the Outlook Object Model does not export an Item_Delete( ) event. Thus the CTI uses the method shown in FIG. 8 to check whether the User Properties match the database keys. Similarly for the duration of a live call translation function the CTI must continue to monitor the Calendar for any deletions or changes of appointment or user profile setting. If an appointment is cancelled or changed then corresponding changes are carried out in the database 21.

Thus referring to FIG. 8, at run time a “delete expired reminders and diverts” process is started (80) which retrieves pending reminder and divert requests from the database 21 (85). The appropriate users calendar/schedule is opened (90) and the appointments data and database data compared for compatibility (95).

If there is an incompatibility between the data held in the database 21 and the users calendar then the database entry is deleted and any corresponding special telephony request is amended (100). If the appointment data is still valid then the reminder which triggered the run time request (80) or the divert of the causal incoming telephony call is effected (105).

Although the above specific description uses desktop CTI server and Microsoft Outlook clients there are other equally valid implementations of the invention using other calendar programs and other database and CTI information. For example, routing rules could be stored in an integrated desktop email/calendar/contacts/CTI server in which when a call arrives the user profile is opened with the user calendar and routing determined. All rules could alternatively be held in a call translation application or there may be a hybrid system having in which both a call translation application and a CTI server could each have some rules with a determination of those rules which are over riding.

Although for example only the description hereinbefore assumes that the user profile data is located in a connectionless network with calls originating and terminating in a connection oriented network it will be realised that using, for example, voice over IP methods calls could also originate and/or terminate in the connectionless network. The invention provides flexible user controllable re-direction and termination of telephony calls using user resources (Calendar/Schedule programs for example) which are more specifically directed towards the customers other needs. Thus, once the user has established profile data determining basic re-direction requirements, and/or organisational defaults are provided (for example by an employing organisation) the customer need not take any further action to ensure calls are diverted to an appropriate destination.

Turning then to FIG. 9, a simple system may be provided to enable call redirection between or within networks 10, 10A. A call having a destination in network 10 arrives at a gateway 201 which forwards a signalling message to a routing application on a virtual path 202. The message may include information such as Direct Dialling In destination number, the calling line identity of the caller, and other class of service type information for example. This information is used by a routing application 203 which uses launches an SQL query by way of virtual path 204 to a relational database 205. The agent simply works by consulting on virtual paths 206-209 (representing accesses solely internal to the database 205) to determine a destination from the database 205. The destination data held in the relational database 205 is derived from data held in a specific user profile 210, “white pages” 211, translation tables 212 and rule table 213.

The user profile 210, individual to a user, includes the user's personal calendar or schedule 214, details of the user's contacts (e.g. an address book function), a journal 216, and rules 217. The rules are derived in part from the White pages information and in part from information supplied by the user.

Thus the white pages 211 include account details, user information 219 and organisational information 220 which can provide default rules 221 which are added to or substituted for the personal rules at 217.

The account identity from 218 may be associated with a virtual telephony identity as shown in the look up table 212, the combination of account identity and rule identity from 217 giving rise to access specific rules from table 213.

Thus in the example shown, telephone number 11111-111-111 (see 212) has an account identity “1”. The rules from 217 give a start point for the particular user so that according to rule 3, if the calling line identity is 02345 678 901 2 AND it is between 12 mid day and 3 p.m. (1500 hrs) on the Feb. 29, 2000 the call is to be directed to 01234 567 8902.

Any call directed to the same number on Jan. 1, 2000 between 8.00 am and 6 p.m. (1800 hrs) is to be directed to 01234 567 8901 (rule 2) otherwise (rule 1) the call is to be redirected to 01 234 567 8900.

The appropriate destination will be reflected to the gateway 201 and the incoming call redirected accordingly.

Thus the rule identity (col. 222) in accordance with the account identity (col. 223) uses the CLIs (signalling conditions col. 224) in combination with start date (col. 225) and end date (col. 226) and start time (col. 227) and end time (col. 228) to determine a destination (col. 229).

FIG. 10 shows the routing rules interface as it appears to a user using Microsoft Outlook for example.

Thus, when the user enters an appointment in the calendar program the telephony tab opens a window offering telephony options for this appointment. Thus call diversion provides a drop down screen offering a number of options with an alternative of a single click diversion to an answering service such as the British Telecommunications plc network based answering service known as Call Minder (Trademark).

The telephony option also permits a network generated reminder to be sent again using a drop down screen offering the reminder for signalling to (e.g.) a pager, home telephone, desk telephone, mobile telephone or other node.

The routing routes in the example given in FIG. 9 are confined to being conditional on the fields that the database 205 provides. Thus they may be conditional on dates and times and the system is slightly inflexible.

However, using active script processing and agent “helpers” a far more flexible call diversion function may be provided. Thus referring to FIG. 11, when the gateway 201 forwards a message to the routing application to query the database, the SQL query message to the database 205 results in a return message to the application function 231 which returns a script and optionally a helper identity.

Thus referring additionally to FIG. 12, when the processing from the database 205 provides a simple script identity a script engine 232 runs the script using the relevant data extracted directly from the database at the time of an incoming call.

Accordingly, as shown in FIG. 12 a simple script using DDI (direct Dialling In) CLI (Calling Line Identity) and TLI (Destination telephone line identity) runs using the calendar and telephony rules associated with a particular user.

Now, as shown by script 233 (derived from the account id and virtual telephone id), the primary rule looks first at the CLI to determine if the CLI is “P”. All calls originating from “P” are routed to the user's mobile telephone so that the script returns the mobile telephone number to the gateway and terminates.

If the CLI is not “P” the CLI is now examined to determine if the call is from CLI “Q” or CLI “R” and if so the time of day is considered so that calls from “Q” or “R” are routed to a call answering function before 9 am or after 5 pm (i.e. calls outside normal office hours).

All calls not from P, Q or R are routed to the office telephone number as will calls originating from Q and R during normal office hours.

Thus the script shown may return one of three destinations to the gateway these being the user's mobile telephony number, call minder address or office telephone number. The simple script here does not take account of user calendar information, only of call origin and time of day. However, it will be realised that calendar information may be introduced in to the rules in a similar manner to that hereinbefore described

It will however be appreciated that day of week or other simple rules may be simply introduced to a script determining a preferential order and ending with a default condition for any call not previously captured.

It is also noted that the profile scripting may include additional destinations or multiple destinations to which selected calls may be sequentially routed in the event that the call is not answered within a pre-determined period. In a further alternative profile multiple destinations may be connected simultaneously to ensure that at least one connection may be effected.

A more complex script using a helper is to be seen in FIG. 13 to which reference is now made. In this example the routing rules are too complex to be expressed and cannot be directly evaluated in the application script. Thus on receipt of a call the script identity is returned as before together with one or more helper identities. The helper classes are loaded dynamically at run time. Helpers return Boolean results (yes/no). Accordingly after considering a specific appointment during which all calls are routed to the call answering service (If date =Feb. 29, 2000 and time is between 1400 and 1500) the program uses the InMeeting helper which will use time and date information to consult the user profile Calendar data and if the answer from the InMeeting helper is YES then the IsContact helper is launched to determine if the meeting is with “P” and if the answer is again YES then the call is routed to the user's mobile telephony number. If the answer returned by either of these helpers is no, then the InMeeting helper is again launched and if a YES is returned the incoming call is routed to the call answering service. A NO return from the helper ensures that the default routing of the User's Office telephone number is used.

Turning now to FIG. 14, the invention provides a simple reminder function using the calendar facility. Thus if the user calendar function passes a reminder request message to the application suite a script is returned together with helpers if required. The script is processed to provide a destination for the reminder call which may cause a pager message, voice message to mobile/desk/home telephone or a computer message display.

1. A telecommunications interface in a communications network, the interface comprising means responsive to each call to one of a plurality of users of the network to access user provided profile data at a node of the network, said profile data relating to the respective user and to determine from said profile data and from data defining identity of a calling party in a current call a preferred destination for the current call in either the originating network or in an alternative network characterised in that the user profile data is derived from a schedule or electronic diary to determine from location data entered by the user a preferred destination for the current call.

2. A telecommunications interface as claimed in claim 1 in which the interface is between a connection oriented network and a connectionless network, the interface using user provided profile data in the connectionless network to determine a preferred destination for the current call.

3. A telecommunications interface as claimed in claim 2 in which both the originating call and the preferred destination are in the connection oriented network.

4. A telecommunications interface as claimed in claim 2 in which the originating call and the preferred destination are one in each of the connectionless network and the connection oriented network.

5. A telecommunications interface as claimed in any preceding claim in which the data defining the calling party is calling line identification (CLI) data originating in the connection oriented network.

6. A telecommunications interface as claimed in any preceding claim in which the profile data includes data defining a preferred destination for each of a plurality of specified CLIs.

7. A telecommunications interface as claimed in claim 6 in which each of said plurality of CLI's has respective data defining time related destination identities.

8. A telecommunications interface as claimed in claim 6 or claim 7 in which there is data defining a single profile for a plurality of specified CLI's.

9. A telecommunications interface as claimed in any preceding claim in which the user profile data includes data defining a preferred destination for any call originating other than from a specified CLI or CLIs.

10. A telecommunications interface as claimed in any preceding claim in which the user profile data is time oriented.

11. A telecommunications interface as claimed in any preceding claim in which the profile data is call type oriented.

12. A telecommunications interface as claimed in any preceding claim include means responsive to user profile data to transmit to a user telephone appointment or alarm information.

13. A telecommunications interface as claimed in claim 12 in which the telephone appointment or alarm information is transmitted to a user telephone using interactive voice messaging.

14. A telecommunications interface as claimed in claim 12 in which the appointment or alarm information is transmitted to the user by transmitting a data message to the user telephone or to a pager.

15. A telecommunications interface as claimed in any preceding claim in which the profile data includes, for at least one caller identity, more than one preferred destination to which a call may be connected, each such destination being attempted sequentially.

16. A telecommunications interface as claimed in any preceding claim in which the profile data includes, for at least one caller identity, more than one preferred destination to which a call may be connected, each such destination being attempted simultaneously.

17. A telecommunications routing agent responsive to calls directed to a communications user's address to determine, from data derived from the respective communications user's personal electronic schedule and a respective personal profile script, a routing within at least one telecommunications or data network for each such call, said routing being further dependent upon the identity of a calling party.

18. A telecommunications routing agent as claimed in claim 17 the destination routing is returned to a gateway to permit routing of calls in a connection oriented network.

19. A telecommunications routing agent as claimed in claim 17 or claim 18 in which the agent selects a script in respect of each call to be handled, each such script being derived from user provided profile data.

20. A telecommunications routing agent as claimed in claim 19 in which a selected script uses at least one helper class script, the helper script returning Boolean logic answers in respect of predetermined user function data.
